(19) United States
(12) Patent Application Publication
(10) Pub. No.: US 2026/0365172 A1
(43) Pub. Date: Nov. 19, 2026

(54) Driver Assistance Method and Driver Assistance System for Avoiding a Loss of Time for a Driver

(71) Applicant: Bayerische Motoren Werke Aktiengesellschaft, Muenchen (DE)

(72) Inventor: Wolfgang SPIESSL, Freising (DE)

(21) Appl. No.: 19/679,898

(22) Filed: May 18, 2026

(30) Foreign Application Priority Data
May 19, 2025 (DE) 10 2025 119 230.8

(51) Int. Cl. B60W 30/18; B60W 10/20; B60W 50/14

(52) U.S. Cl. CPC B60W 30/18154; B60W 10/20; B60W 50/14; B60W 2540/223; B60W 2540/225; B60W 2552/10; B60W 2552/53; B60W 2555/60; B60W 2556/45; B60W 2710/20

(57) ABSTRACT

A driver assistance method for assisting a driver of a motor vehicle in order to avoid a loss of time, and a corresponding driver assistance system are provided. A traffic signal installation having a stop line and a stopping area for the motor vehicle which adjoins the stop line are detected. A first line of sight directed toward the traffic signal installation from a first position within the stopping area and an obstacle blocking the first line of sight are also detected. A second line of sight directed toward the traffic signal installation from a second position within the stopping area is also detected, the second line of sight being clear of the obstacle. It is also detected that the traffic signal installation is displaying a stop signal and the stopping area is clear of vehicles. Finally, the motor vehicle is stopped in the stopping area, the second position corresponding to a head position of the driver.

### CROSS REFERENCE TO RELATED APPLICATION

This application claims priority under 35 U.S.C. § 119 from German Patent Application No. 10 2025 119 230.8, filed May 19, 2025, the entire disclosure of which is herein expressly incorporated by reference.

### BACKGROUND AND SUMMARY

The invention relates to a driver assistance method for assisting a driver of a motor vehicle in order to avoid a loss of time. In addition, the invention relates to a driver assistance system for carrying out the driver assistance method.

Driver assistance systems are used to assist the driver of a motor vehicle in certain driving situations. The driver is assisted in particular with regard to safety aspects, but also with regard to aspects of comfort or economy. The variety of driver assistance systems ranges from a parking aid by means of ultrasound via a lane change assist system or an automatic distance warning system by means of radar or lidar to traffic sign recognition by means of a camera.

JP 5990941 B2 discloses a method for avoiding a traffic situation in which the view of a traffic signal installation for a driver of a motor vehicle is obstructed by another motor vehicle. In particular, the distance between the motor vehicle of the driver and the other motor vehicle and the dimensions of the other motor vehicle in conjunction with the respective distance from the traffic signal installation are essential parameters of the disclosed method.

JP 6365134 B2 discloses a method for avoiding a traffic situation in which the view of a traffic signal installation for a driver of a motor vehicle is likewise obstructed by another motor vehicle. Besides the distance between the motor vehicle and the other motor vehicle and the dimensions of the other motor vehicle, in particular the width and length of the other motor vehicle, the width of the lane is included in the disclosed method as a further parameter.

EP 3 590 781 B1 discloses a method for avoiding a traffic situation in which the view of a traffic signal installation for a driver of a motor vehicle is likewise obstructed by another motor vehicle. Moreover, the method in EP 3 590 781 B1 discloses avoiding a traffic situation in which incorrect traffic management is associated with the driver of the motor vehicle.

A common aspect of the prior art is that, in a traffic situation in which a motor vehicle is stationary at a stop line for a traffic signal installation or is approaching the stop line of the traffic signal installation, no check is performed to ascertain whether the motor vehicle is positioned or will be positioned correctly in relation to the stop line so that the driver of the motor vehicle can clearly see the traffic signal installation. In particular, no check is performed to ascertain whether, in the case of a motor vehicle which is the first to be stationary at the stop line, the driver of the motor vehicle can see a change in the traffic signal installation from a stop signal to a go signal. Failure to see the change can mean a loss of time for the driver of the motor vehicle. If the change from a stop signal to a go signal is not seen, the resulting traffic situation may moreover be frustrating or disagreeable for the driver of the motor vehicle if the driver of the motor vehicle which is the first to be stationary at the stop line is made aware of the change by other motor vehicles located behind the first motor vehicle. In addition, failure to see the stop signal change to a go signal can generally impede the flow of traffic, in particular when the traffic density is high.

Against this background, the invention is based on the first object of providing a driver assistance method which, by avoiding a loss of time, improves the driving comfort of a driver of a motor vehicle and generally the flow of traffic. The invention is also based on the second object of providing an improved driver assistance system for carrying out the driver assistance method.

These objects are achieved by a driver assistance method and system having the features of the independent claims. The dependent claims relate to advantageous embodiments of the invention.

The driver assistance method according to the invention is for assisting a driver of a motor vehicle in order to avoid a loss of time and comprises the following method steps.

In a first method step, a traffic signal installation is detected, the traffic signal installation having a stop line. The traffic signal installation can be detected, for example, using a sensor system which scans the surroundings of the motor vehicle. Typically, camera sensors, ultrasonic sensors and/or radar sensors are used for this purpose. The surroundings are first scanned for a traffic signal installation, and a further method step is used to detect or determine that the traffic signal installation has a stop line. The stop line can likewise be detected using the sensor system. Alternatively, the stop line can be detected using matching against a database. This involves the detected traffic signal installation being matched against the database and the traffic signal installation being determined as having a stop line.

In a further method step, a stopping area for the motor vehicle which adjoins the stop line is detected. The stopping area can likewise be detected using the sensor system which scans the surroundings of the motor vehicle. The already mentioned or further camera sensors can again be used for this purpose. Alternatively, the stopping area can be determined by way of comparison with a database if the traffic signal installation has, for example, a special stopping area, as is the case for a switchable traffic signal installation. The stopping area of the traffic signal installation is dimensioned in such a way that a motor vehicle can be brought to a stop at different positions within the stopping area.

According to the invention, a further method step is used to detect a first line of sight directed toward the traffic signal installation from a first position within the stopping area. The first line of sight can be detected, for example, by sensor means if there are markings in the stopping area or in the surroundings of the stopping area that can be used to determine the first position and, using that, the first line of sight. Camera sensors can again be used for this purpose.

A further method step is used to detect an obstacle blocking the first line of sight. The obstacle can likewise be detected using the sensor system which scans the surroundings of the motor vehicle. By way of example, the obstacle can be detected by means of camera sensors, lidar sensors and/or ultrasonic sensors, and a further method step can be used to determine that the obstacle is blocking the first line of sight.

A further method step is used to detect a second line of sight directed toward the traffic signal installation from a second position within the stopping area. The second line of sight is clear of the obstacle. The second line of sight can likewise be detected, for example, by sensor means if there are markings in the stopping area or in the surroundings of the stopping area that can be used to determine the second position and, using that, the second line of sight. Camera sensors can again be used for this purpose. The camera sensors can likewise be used to detect that the obstacle is not blocking the second line of sight.

A further method step is used to detect that the traffic signal installation is displaying a stop signal. The traffic signal installation can be detected as displaying a stop signal by means of further camera sensors or by means of the already mentioned camera sensors.

A further method step is moreover used to detect that the stopping area is clear of a motor vehicle. The stopping area can be detected as being clear of vehicles by camera sensors, lidar sensors and/or ultrasonic sensors.

A further method step is used to stop the motor vehicle in the stopping area. The motor vehicle is stopped in the stopping area in such a way that the second position corresponds to a head position of the driver.

The invention's stopping of the motor vehicle in a position in which the driver of the motor vehicle has full visibility of the traffic signal installation enables the driver to start moving the motor vehicle as soon as the traffic signal installation switches off the stop signal and displays the go signal. This firstly avoids a loss of time for the driver of the motor vehicle. Secondly, a traffic situation in which the driver could be frustrated if other motor vehicles located behind the motor vehicle of the driver make the driver aware of the change of lights is avoided. In addition, a traffic situation that impedes the flow of traffic is avoided. The present invention thus maintains the flow of traffic further.

According to one advantageous driver assistance method, the obstacle is detected inside the motor vehicle. Moreover, an eye position of the driver is detected. The motor vehicle is also stopped in the stopping area, the second position corresponding to the eye position of the driver.

The detection of the obstacle inside the motor vehicle has the advantage that, besides repositioning of the motor vehicle, the obstacle can possibly be removed by the driver of the motor vehicle.

The obstacle may be, for example, a sun visor which the driver of the motor vehicle can move into the folded-up position, with the result that the sun visor is no longer a visual obstacle.

In addition, there are obstacles in the interior of the motor vehicle which the driver of the motor vehicle cannot remove. For example, an interior mirror can hinder the view of the traffic signal installation for the driver of the motor vehicle, it not being possible to remove the obstacle in this case. Moreover, it is not possible to remove an obstacle in the form of a darkening strip at an upper edge of a windshield, and so the upper edge of the windshield is a permanent obstacle. Furthermore, the obstacle may be a wiping pattern on the windshield that typically arises as a result of dirt, fogging and/or icing. The dirty, fogged or iced-up areas of the wiping pattern on the windshield form the obstacle. Moreover, areas of the windshield that the windshield wiper does not reach form an obstacle.

The advantageous driver assistance method having the feature that the obstacle is detected inside the motor vehicle and the eye position of the driver is detected has the advantage, besides avoiding the loss of time for the driver and maintaining the flow of traffic, of further specifying the driver assistance method for a specific traffic situation.

According to another advantageous driver assistance method, the stop signal is detected for a time at which the motor vehicle will reach the stopping area. The detection of the stop signal in this case comprises a V2X system or stored traffic signal switching times.

The detection of the stop signal for a time in the future at which the motor vehicle will reach the stopping area has the advantage that the motor vehicle can be positioned in advance in such a way that all criteria are met. The criteria in this case are firstly that the view of the traffic signal installation for the driver of the motor vehicle is clear of an obstacle and secondly that the motor vehicle stops as close to the stop line as possible. Moreover, the criteria may also comprise other parameters predefined, for example, by a navigation device or by specific road conditions.

The V2X system of the motor vehicle communicates with the surroundings. When the system communicates with the surroundings, it is possible to inform the motor vehicle of the traffic light signal times in advance, for example from the traffic signal installation itself or from motor vehicles which are located close to the traffic signal installation and detect the current status of a change of lights on the traffic signal installation.

Moreover, the stop signal can be detected for a time in the future by way of matching against stored traffic signal switching times of the traffic signal installation in a database.

The advantageous driver assistance method having the feature that the stop signal is detected for a time at which the motor vehicle will reach the stopping area has the advantage, besides avoiding the loss of time for the driver and maintaining the flow of traffic, of further specifying the driver assistance method for a specific traffic situation.

According to another advantageous driver assistance method, a multiplicity of obstacle-free positions within the stopping area are detected, obstacle-free lines of sight being directed toward the traffic signal installation from the obstacle-free positions. The obstacle-free lines of sight in this case are clear of the obstacle blocking the first line of sight. In addition, the second position is at the shortest distance from the stop line in relation to the obstacle-free positions.

The obstacle-free positions within the stopping area can be detected, for example, by sensor means if there are markings in the stopping area or in the surroundings of the stopping area that can be used to determine the obstacle-free positions and, using those, the obstacle-free lines of sight. Camera sensors can again be used for this purpose.

A multiplicity of obstacle-free positions are also detected, each obstacle-free position being compared with the second position. In the advantageous driver assistance method, the second position is established as being at a shorter distance from the stop line than each obstacle-free position of the obstacle-free positions. That is to say that the motor vehicle in the advantageous vehicle position in which the head position of the driver is in the second position is at the shortest distance from the stop line. That is also to say, in turn, that the driver's view of the traffic signal installation is blocked, or there is a first line of sight blocked by the obstacle, in each vehicle position of the motor vehicle between the advantageous vehicle position and the stop line.

The advantageous driver assistance method having the feature of the comparison between the second line of sight and a multiplicity of obstacle-free lines of sight, with the result that the second position is at a shorter distance from the stop line than the obstacle-free positions, has the advantage, besides avoiding the loss of time for the driver and maintaining the flow of traffic, of further specifying the driver assistance method for a specific traffic situation. In particular, this ensures that the motor vehicle is stopped as close to the stop line as possible.

According to another advantageous driver assistance method, the traffic signal installation comprises a first display unit and a second display unit. The first line of sight is directed toward the first display unit and the second line of sight is directed toward the second display unit.

The traffic signal installation comprises the first display unit and the second display unit, resulting in greater coverage of a field of view of a driver of a motor vehicle. The first display unit and the second display unit both show the same traffic light signal. In the typical application of the present invention, the first display unit and the second display unit each display a stop signal.

Should the first display unit be concealed from a driver of a motor vehicle by an obstacle, the driver of the motor vehicle can also see the traffic light signals in the second display unit and act accordingly.

Splitting the traffic signal installation into the first display unit and the second display unit results in the advantage that the function of the traffic signal installation is not restricted if the view of the traffic signal installation for the driver of the motor vehicle is partially blocked.

In this case, there is a first line of sight in the direction of the first display unit and a second line of sight in the direction of the second display unit.

The advantageous driver assistance method having the feature that the first line of sight is directed toward the first display unit and the second line of sight is directed toward the second display unit has the advantage, besides avoiding the loss of time for the driver and maintaining the flow of traffic, of further specifying the driver assistance method for a specific traffic situation. In particular, this ensures that the motor vehicle is stopped as close to the stop line as possible if a second display unit is integrated into the driver assistance method.

According to another advantageous driver assistance method, a first lane and a second lane are detected, the first line of sight in the first lane and the second line of sight in the second lane being detected.

The advantageous driver assistance method encompasses the first lane and the second lane, resulting in greater coverage of the possible vehicle positions for the motor vehicle in which the motor vehicle can be positioned on the road in such a way that firstly a view for a driver of a motor vehicle is not blocked by an obstacle and secondly the motor vehicle stops as close to the stop line as possible.

Should there be an obstacle, so that there is no possibility of stopping the motor vehicle as close to the stop line of the traffic signal installation as possible in the first lane, the motor vehicle can be positioned in the second lane in order to allow the driver of the motor vehicle to have a clear view of the traffic signal installation.

In this case, there is a first line of sight in the direction of the traffic signal installation from the first lane and a second line of sight in the direction of the traffic signal installation from the second lane.

The advantageous driver assistance method having the feature that the first line of sight in the first lane and the second line of sight in the second lane are detected has the advantage, besides avoiding the loss of time for the driver and maintaining the flow of traffic, of further specifying the driver assistance method for a specific traffic situation. In particular, this ensures that the motor vehicle is stopped as close to the stop line as possible if a second lane is integrated into the driver assistance method.

According to another advantageous driver assistance method, a navigation path determined by a navigation device is detected. Moreover, the second lane is detected on the navigation path.

The detection of a navigation path by a navigation device has the advantage that only lanes that are on the route of the driver of the motor vehicle are proposed or taken into account by the driver assistance method.

For example, the driver assistance method disregards a lane which, although it meets all criteria in that the driver of the motor vehicle has a clear view of the traffic signal installation and the motor vehicle stops directly at the stop line, is not on the route of the driver of the motor vehicle and would thus guide the driver of the motor vehicle in a wrong direction.

The navigation device can be a commercially available device which can display a navigation route to the driver of the motor vehicle. This also includes applications or apps that can communicate information about navigation on a mobile device, for example. Besides the typical mobile devices such as smartphones and smart watches, this also encompasses digitally equipped rings and digitally equipped glasses.

The advantageous driver assistance method having the feature that the second lane is located on the navigation path has the advantage, besides avoiding the loss of time for the driver and maintaining the flow of traffic, of further specifying the driver assistance method for a specific traffic situation. In particular, this ensures that the motor vehicle is not guided into a lane which leads in a wrong direction, that is to say leads in a direction which is not intended by the driver of the motor vehicle.

According to another advantageous driver assistance method, a widened lane is detected. Moreover, the first position and the second position are detected at different positions perpendicular to the course of the widened lane.

The advantageous driver assistance method encompasses the widened lane, resulting in greater coverage of the possible vehicle positions for the motor vehicle perpendicular to the course of the widened lane in which the motor vehicle can be positioned on the road in such a way that firstly a view for a driver of a motor vehicle is not blocked by an obstacle and secondly the motor vehicle stops as close to the stop line as possible.

Should there be an obstacle, so that there is no possibility of stopping the motor vehicle as close to the stop line of the traffic signal installation as possible on one side perpendicular to the course of the widened lane, the motor vehicle can be positioned on the other side of the lane, perpendicular to the course of the widened lane, in order to allow the driver of the motor vehicle to have a clear view of the traffic signal installation.

The advantageous driver assistance method having the feature that the first position and the second position are detected at different positions perpendicular to the course of the widened lane has the advantage, besides avoiding the loss of time for the driver and maintaining the flow of traffic, of further specifying the driver assistance method for a specific traffic situation. In particular, this ensures that the motor vehicle is stopped as close to the stop line as possible if utilization of a lateral offset of the motor vehicle results in the width of the lane being integrated into the driver assistance method.

According to another advantageous driver assistance method, the motor vehicle is autonomously steered into the stopping area of the traffic signal installation.

The motor vehicle can be autonomously steered into the stopping area using typical systems, for example camera systems, lidar systems, radar systems, ultrasonic systems or a combination of these systems.

The advantageous driver assistance method having the feature that the motor vehicle is autonomously steered into the stopping area has the advantage, besides avoiding the loss of time for the driver and maintaining the flow of traffic, of further specifying the driver assistance method for a specific traffic situation.

According to another advantageous driver assistance method, the driver of the motor vehicle is guided into the stopping area by means of signals.

The driver of the motor vehicle can be guided into the stopping area by different systems. For example, the driver can be guided into the stopping area by simple visual signals in the form of individual lamps inside the motor vehicle or by simple audible signals via loudspeakers of the motor vehicle. The driver of the motor vehicle can also be guided into the stopping area by a more complex system, for example by an infotainment system of the motor vehicle. To that end, the associated information can be communicated to the driver of the motor vehicle for example using a driver display, using a center console display or using a head-up display.

The advantageous driver assistance method having the feature that the driver of the motor vehicle is guided into the stopping area by means of signals has the advantage, besides avoiding the loss of time for the driver and maintaining the flow of traffic, of further specifying the driver assistance method for a specific traffic situation.

The driver assistance system according to the invention is designed to carry out a driver assistance method according to the invention.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a first traffic situation for an advantageous driver assistance method, in which a motor vehicle stops in a vehicle position in which the driver of the motor vehicle has a clear view of the traffic signal installation.

FIG. 2 shows a further traffic situation for another advantageous driver assistance method, in which a motor vehicle is at the shortest distance from the stop line.

FIG. 3 shows a further traffic situation for another advantageous driver assistance method, in which the traffic signal installation has a first display unit and a second display unit.

FIG. 4 shows a further traffic situation for another advantageous driver assistance method, in which the first road has a first lane and a second lane.

FIG. 5 shows a further traffic situation for another advantageous driver assistance method, in which the first road has a widened lane.

### DETAILED DESCRIPTION OF THE DRAWINGS

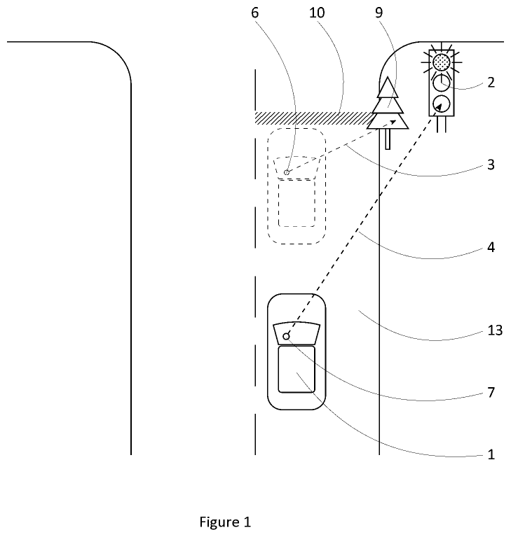

FIGS. 1 to 5 each illustrate a traffic situation in which an advantageous embodiment of a driver assistance method according to the invention is used.

FIGS. 1 to 5 each show a first road that opens into a second road. Arranged at the junction of the first road with the second road is a traffic signal installation 2 which regulates the traffic from the first road onto the second road. The traffic signal installation 2 can display three signals. The first signal is a stop signal, the second signal is a warning signal, and the third signal is a go signal. In FIGS. 1 to 5, the respective traffic signal installation 2 is showing the stop signal.

The respective traffic signal installation 2 in FIGS. 1 to 5 moreover has a stop line 10 at which a motor vehicle 1 stops. Arranged adjoining the stop line 10 is a stopping area 13 in which the motor vehicle 1 comes to a standstill. The stopping area 13 in FIGS. 1 to 5 is clear of vehicles, and so the respective motor vehicle 1 is able to stop directly at the stop line 10 or at a freely selectable position in the stopping area 13.

FIGS. 1 to 5 also show an obstacle 9 that can obstruct a view for a driver of a motor vehicle 1 stationary at the stop line 10.

FIG. 1 shows a first traffic situation, in which a motor vehicle 1 is located on the first road and stops at the stop line 10 of the traffic signal installation 2 displaying a stop signal. On the first road, the motor vehicle 1 can stop in two illustrative vehicle positions.

In the first vehicle position of the two illustrative vehicle positions, the motor vehicle 1 would stop directly at the stop line 10. This vehicle position of the motor vehicle 1 on the first road would be a preferred stopping position, since the motor vehicle 1 stops directly at the stop line 10.

In the second vehicle position of the two illustrative vehicle positions, the motor vehicle 1 would stop at a distance from the stop line 10. This vehicle position of the motor vehicle 1 on the first road would not be a preferred stopping position, since the motor vehicle 1 stops too far away from the stop line 10. Another motor vehicle would have room to fill the space between the motor vehicle 1 and the stop line 10. This second vehicle position ought to be avoided.

In FIG. 1, however, there is an obstacle 9 which obstructs the view of a driver of the motor vehicle 1 when the motor vehicle 1 stops directly at the stop line 10. The driver of the motor vehicle 1 cannot see the traffic signal installation 2 in this vehicle position.

This results in a first line of sight 3 directed toward the traffic signal installation 2 from a first position 6 of the driver. The first line of sight 3 is obstructed by the obstacle 9.

However, the obstacle 9 in FIG. 1 does not conceal the traffic signal installation 2 completely. This results in a further vehicle position for the motor vehicle 1, in which the driver of the motor vehicle 1 can see the traffic signal installation 2. This further vehicle position is the second vehicle position of the two illustrative vehicle positions.

In the second vehicle position of the two illustrative vehicle positions, the obstacle 9 does not obscure the line of sight between the driver of the motor vehicle 1 and the traffic signal installation 2. This results in a second line of sight 4 directed toward the traffic signal installation 2 from a second position 7 of the driver. The second line of sight 4 is not obstructed by the obstacle 9.

Stopping the motor vehicle 1 in the second vehicle position in the stopping area 13, with the result that the second position 7 corresponds to the head position of the driver, has the effect that the driver of the motor vehicle 1 can see the traffic signal installation 2 and thus also a change of lights on the traffic signal installation 2. The driver of the motor vehicle 1 is thus able to start moving the motor vehicle 1 promptly when a stop signal changes to a go signal.

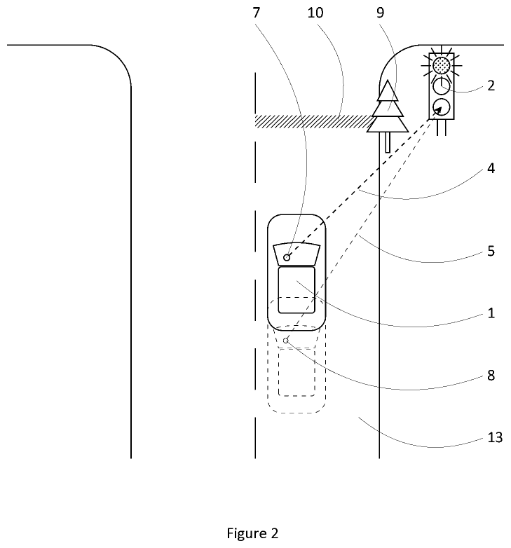

FIG. 2 shows a further traffic situation, in which a motor vehicle 1 is located on the first road and stops at the stop line 10 of the traffic signal installation 2 displaying a stop signal. On the first road, the motor vehicle 1 can stop in two illustrative vehicle positions.

In the first vehicle position of the two illustrative vehicle positions, the motor vehicle 1 stops in the stopping area 13 in such a way that the driver has a clear view of the traffic signal installation 2, with the result that the driver of the motor vehicle 1 can see the traffic signal installation 2 and thus a change from a stop signal to a go signal. This results in a second line of sight 4 which is directed toward the traffic signal installation 2 from a second position 7, or a head position of the driver, and is clear of the obstacle 9, i.e. is not blocked by the obstacle 9.

In the second vehicle position of the two illustrative vehicle positions, the motor vehicle 1 likewise stops in the stopping area 13 in such a way that the driver of the motor vehicle 1 has a clear view of the traffic signal installation 2, with the result that the driver can see the traffic signal installation 2 and thus a change from a stop signal to a go signal. This results in a line of sight which is directed toward the traffic signal installation 2 from a head position of the driver and is clear of the obstacle 9, i.e. is not blocked by the obstacle 9.

This resulting line of sight is one of the obstacle-free lines of sight 5, the obstacle-free lines of sight 5 being directed toward the traffic signal installation 2 from head positions of the driver, or obstacle-free positions 8, and not being blocked by the obstacle 9. The obstacle-free positions 8 in this case are further away from the stop line 10 than the second position 7.

That is to say that, in contrast to the second vehicle position, the motor vehicle 1 is at the shortest distance from the stop line 10 in the first vehicle position, in which there is the second line of sight 4.

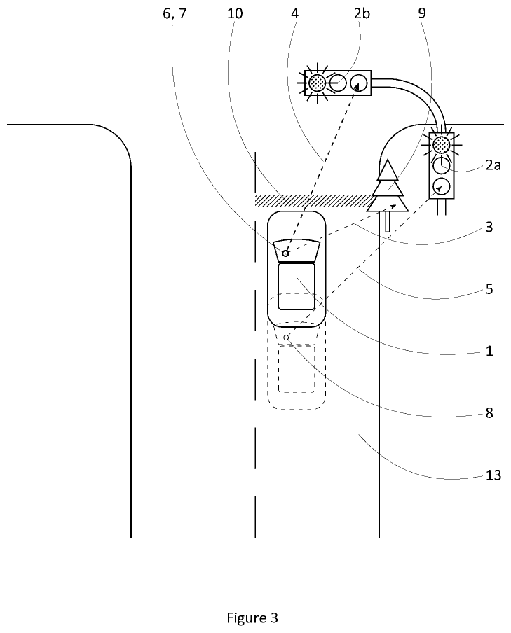

FIG. 3 shows a further traffic situation, in which a motor vehicle 1 is located on the first road and stops at the stop line 10 of the traffic signal installation 2 displaying a stop signal. In FIG. 3, the traffic signal installation 2 has a first display unit 2a and a second display unit 2b, the second display unit 2b being arranged over the first road. Both the first display unit 2a and the second display unit 2b are displaying the stop signal.

On the first road, the motor vehicle 1 can stop in two illustrative vehicle positions.

In the first vehicle position of the two illustrative vehicle positions, the motor vehicle 1 stops directly at the stop line 10. In this vehicle position, the driver of the motor vehicle 1 cannot see the first display unit 2a. The obstacle 9 blocks the view between the driver of the motor vehicle 1 and the first display unit 2a. There is thus a first line of sight 3 to the first display unit 2a which is blocked by the obstacle 9.

As in FIG. 2, the motor vehicle 1 can stop further away from the stop line 10 in the second vehicle position of the two illustrative vehicle positions, with the result that the view between the driver of the motor vehicle 1 and the first display unit 2a is not blocked by the obstacle 9. In this vehicle position, there could be a second line of sight 4 which is directed toward the first display unit 2a from the head position and is not blocked by the obstacle 9.

However, besides the first display unit 2a, the traffic signal installation 2 comprises the second display unit 2b, and so in the second vehicle position the motor vehicle 1 is not at the shortest distance from the stop line 10. As a result, the second vehicle position does not have a second line of sight 4 which is directed toward the traffic signal installation 2 from the head position and is clear of the obstacle 9. The second vehicle position has one of the obstacle-free lines of sight 5 which are directed toward the traffic signal installation 2 and are clear of the obstacle 9, but whose obstacle-free positions 8 are not at the shortest distance from the stop line 10.

In the first vehicle position, in which the motor vehicle 1 stops directly at the stop line 10, the driver of the motor vehicle 1 has a clear view of the second display unit 2b. That is to say that there is a second line of sight 4 to the second display unit 2b which is not blocked by the obstacle 9.

Since the motor vehicle 1 stops directly at the stop line 10, the motor vehicle 1 is at the shortest distance from the stop line 10 compared to other vehicle positions.

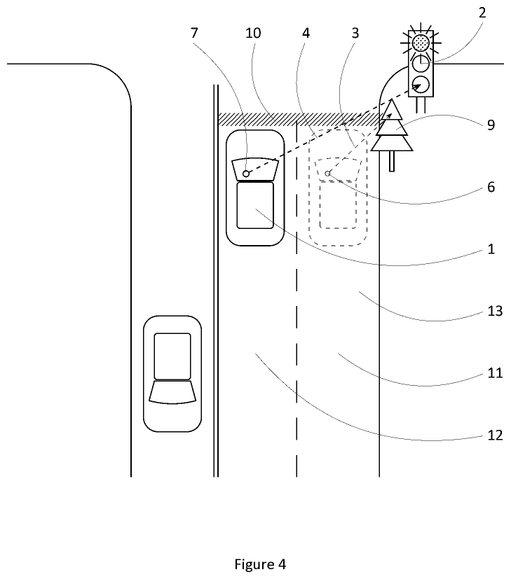

FIG. 4 shows a further traffic situation, in which a motor vehicle 1 is located on the first road and stops at the stop line 10 of the traffic signal installation 2 displaying a stop signal.

In FIG. 4, the first road has two lanes in one direction, that is to say a first lane 11 and a second lane 12. On the first road, the motor vehicle 1 can stop in two illustrative vehicle positions. That is to say that the motor vehicle 1 can stop in different vehicle positions along the first lane 11 or along the second lane 12.

In the first vehicle position of the two illustrative vehicle positions in the first lane 11, the motor vehicle 1 stops directly at the stop line 10. In this vehicle position, the driver of the motor vehicle 1 cannot see the traffic signal installation 2. The obstacle 9 blocks the view between the driver of the motor vehicle 1 and the traffic signal installation 2. There is thus a first line of sight 3 blocked by the obstacle 9.

As in FIG. 2, the motor vehicle 1 could stop in a further vehicle position (not shown) further away from the stop line 10 in the first lane 11. In the further vehicle position, the view between the driver of the motor vehicle 1 and the traffic signal installation 2 would not be blocked by the obstacle 9. In this vehicle position, there could be a second line of sight 4 which is directed toward the traffic signal installation 2 from the head position and is not blocked by the obstacle 9.

However, besides the first lane 11, the first road has the second lane 12, and so in the further vehicle position in the first lane 11 the motor vehicle 1 would not be at the shortest distance from the stop line 10. As a result, the further vehicle position does not have a second line of sight 4 which is directed toward the traffic signal installation 2 from the head position and is clear of the obstacle 9. The further vehicle position has one of the obstacle-free lines of sight 5 which are directed toward the traffic signal installation 2 and are clear of the obstacle 9, but whose obstacle-free positions 8 are not at the shortest distance from the stop line 10.

In the second vehicle position of the two illustrative vehicle positions, the motor vehicle 1 likewise stops directly at the stop line 10, but in the second lane 12. In this vehicle position, the driver of the motor vehicle 1 has a clear view of the traffic signal installation 2, and so there is a second line of sight 4 which is directed toward the traffic signal installation 2 from the second position 7 and is clear of the obstacle 9.

Since the motor vehicle 1 stops directly at the stop line 10, the motor vehicle 1 is at the shortest distance from the stop line 10 compared to other vehicle positions in the second lane 12.

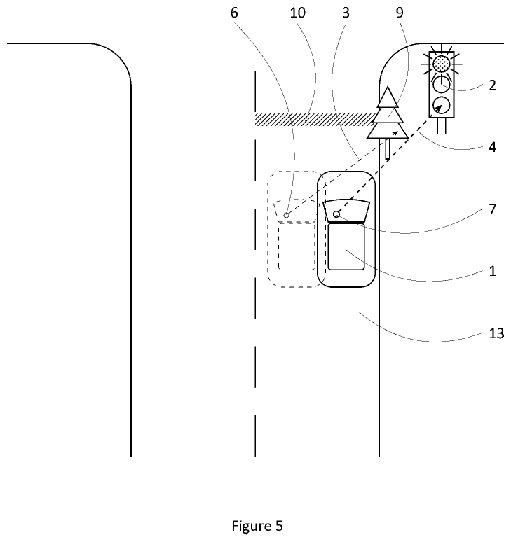

FIG. 5 shows a further traffic situation, in which a motor vehicle 1 is located on the first road and stops at the stop line 10 of the traffic signal installation 2 displaying a stop signal.

In FIG. 5, the first road has a widened lane. On the first road, the motor vehicle 1 can stop in two illustrative vehicle positions. That is to say that the motor vehicle 1 can stop at different positions perpendicular to the course of the widened lane.

In the first vehicle position of the two illustrative vehicle positions, the motor vehicle 1 stops in a vehicle position in which there is a first line of sight 3. In this vehicle position, the driver of the motor vehicle 1 accordingly does not have a clear view of the traffic signal installation 2, as the first line of sight 3 is blocked by the obstacle 9.

In the second vehicle position of the two illustrative vehicle positions, the motor vehicle 1 is laterally offset perpendicular to the course of the widened lane, that is to say that the motor vehicle 1 is laterally offset in the widened lane in such a way that the driver of the motor vehicle 1 has a clear view of the traffic signal installation 2. As a result, there is a second line of sight 4 which is directed toward the traffic signal installation 2 from the head position, or from the second position 7, and is clear of the obstacle 9.

Stopping the motor vehicle 1 in the second vehicle position in the stopping area 13, with the result that the second position 7 corresponds to the head position of the driver, has the effect that the driver of the motor vehicle 1 can see the traffic signal installation 2 and thus also a change of lights on the traffic signal installation 2. The driver of the motor vehicle 1 is thus able to start moving the motor vehicle 1 promptly when a stop signal changes to a go signal.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 motor vehicle
2 traffic signal installation
2a first display unit
2b second display unit
3 first line of sight
4 second line of sight
5 obstacle-free lines of sight
6 first position
7 second position
8 obstacle-free positions
9 obstacle
10 stop line
11 first lane
12 second lane
13 stopping area

What is claimed is:

1. A driver assistance method for assisting a driver of a motor vehicle in order to avoid a loss of time, comprising:
detecting a traffic signal installation having a stop line;
detecting a stopping area for the motor vehicle which adjoins the stop line;
detecting a first line of sight directed toward the traffic signal installation from a first position within the stopping area;
detecting an obstacle blocking the first line of sight;
detecting a second line of sight directed toward the traffic signal installation from a second position within the stopping area, the second line of sight being clear of the obstacle;
detecting that the traffic signal installation is displaying a stop signal and the stopping area is clear of vehicles; and
stopping the motor vehicle in the stopping area, the second position corresponding to a head position of the driver.

2. The driver assistance method according to claim 1, further comprising:
detecting the obstacle inside the motor vehicle;
detecting an eye position of the driver; and
stopping the motor vehicle in the stopping area, the second position corresponding to the eye position of the driver.

3. The driver assistance method according to claim 1, further comprising:
detecting the stop signal for a time at which the motor vehicle will reach the stopping area, the detecting comprising a V2X system or stored traffic signal switching times.

4. The driver assistance method according to claim 1, further comprising:
detecting a multiplicity of obstacle-free positions within the stopping area, from which obstacle-free lines of sight are directed toward the traffic signal installation in a manner clear of the obstacle, the second position being at a shortest distance from the stop line in relation to the obstacle-free positions.

5. The driver assistance method according to claim 1, wherein
the traffic signal installation comprises a first display unit and a second display unit,
the first line of sight is directed toward the first display unit, and
the second line of sight is directed toward the second display unit.

6. The driver assistance method according to claim 1, further comprising:
detecting a first lane and a second lane; and
detecting the first line of sight in the first lane and the second line of sight in the second lane.

7. The driver assistance method according to claim 6, further comprising:
detecting a navigation path determined by a navigation device; and
detecting the second lane on the navigation path.

8. The driver assistance method according to claim 1, further comprising:
detecting a widened lane; and
detecting the first position and the second position at different positions perpendicular to a course of the widened lane.

9. The driver assistance method according to claim 1, further comprising:
autonomously steering the motor vehicle into the stopping area, or
guiding the driver of the motor vehicle into the stopping area via signals.

10. A driver assistance system for carrying out driver assistance for a driver, comprising:
a control unit comprising a processor and associated memory operatively configured to:
detect a traffic signal installation having a stop line;
detect a stopping area for the motor vehicle which adjoins the stop line;
detect a first line of sight directed toward the traffic signal installation from a first position within the stopping area;
detect an obstacle blocking the first line of sight;
detect a second line of sight directed toward the traffic signal installation from a second position within the stopping area, the second line of sight being clear of the obstacle;
detect that the traffic signal installation is displaying a stop signal and the stopping area is clear of vehicles; and
stop the motor vehicle in the stopping area, the second position corresponding to a head position of the driver.
